(19) United States
(12) Patent Application Publication
(10) Pub. No.: US 2003/0144048 A1
(43) Pub. Date: Jul. 31, 2003

(54) Game and method of gaming including a triangular display

(76) Inventor: Thomas Silva, Mattapoisett, MA (US)

Correspondence Address: Richard L. Sampson, SAMPSON & ASSOCIATES, P.C., 50 Congress Street, Boston, MA, 02109, US

(21) Appl. No.: 10/058,537

(22) Filed: Jan. 28, 2002

(51) Int. Cl. A63F 13/00

(52) U.S. Cl. 463/16; 463/17; 463/18; 463/19; 463/20; 463/30

(57) ABSTRACT

A game and method of gaming including a triangular display. The triangular display includes at least three rows and at least six blocks, each of which includes markings (e.g., stock symbols). In one aspect a game of chance includes a triangular display, a selecting module configured to randomly select at least one winning block from the blocks in the triangular display and means for receiving a wager on one or more of the blocks in the triangular display.

### BACKGROUND OF THE INVENTION

(1) Field of the Invention

The present invention relates generally to apparatuses and methods for gaming and more particularly relates to a pyramid gaming system including optional progressive gaming, commercial advertising, and/or promotional merchandizing.

(2) Background Information

Games of chance such as roulette, lotto, keno, slots, various card games (e.g., blackjack) and the like, are well known. In recent years, there has been a significantly increased interest in gaming and in games of chance. The growth of the gaming industry, and in particular gambling casinos, has been substantial over the past decade. Further, the industry has come to recognize the need for new games and gambling concepts. Further still, many casinos have recognized the need to integrate new and cutting edge technology into their games in order to remain premier gaming providers. Gaming providers also recognize the need to provide games that current and target customers find interesting, enjoyable, exciting, and that include familiar subject matter. This is especially important since typical players often become bored with the repetition of conventional games.

To this end there has been a significant number of new games and gaming methods introduced in recent years. For example, U.S. Pat. No. 6,264,200 to Smith; U.S. Pat. No. 6,227,542 to Cosmi; U.S. Pat. No. 6,083,105 to Ronin et al.; U.S. Pat. No. 6,059,659 to Busch et al.; U.S. Pat. No. 5,934,999 to Valdez; and U.S. Pat. No. 5,775,993 to Fentz, are just a few of those that disclose improvements, gaming machines/apparatuses, and/or methods pertaining to the well known casino game of roulette. Likewise, there has been a significant number of disclosures of new games, gaming methods, and/or gaming machines/apparatuses related to other known casino games such as slots, craps, baccarat, keno, various card games, and the like as well as numerous disclosures of new games and gaming methods.

Nevertheless, despite the significant number and variety of games, there remains a need for new games that provide for an exciting and enjoyable gaming experience. In particular, there remains a need for games of chance that incorporate familiar themes and that appeal to a potentially broad spectrum of players.

### SUMMARY OF THE INVENTION

One aspect of the present invention includes a display for a game of chance. The display includes at least one triangular display section, each of which includes at least three rows and at least six blocks, each of the blocks including markings. The game of chance is selected from the group consisting of a table game, a matching game, vertical reeled slots and a video game. In one variation of this aspect, the markings are representative of a plurality of publicly traded companies, each of the blocks having markings representative of a unique one of the plurality of publicly traded companies.

In another aspect, this invention includes a game of chance. The game of chance includes a triangular display including rows and blocks, the triangular display including at least three of the rows and at least six of the blocks, with each of the blocks including markings. The game of chance further includes a selecting module configured to randomly select at least one winning block from the blocks in the triangular display and means for receiving a wager on one or more of the blocks in the triangular display.

In yet another aspect, this invention includes a method of playing a game of chance. The method includes: providing a triangular display including rows and blocks, the triangular display including at least three of the rows and at least six of the blocks; receiving a wager from a player on one or more of the blocks; randomly selecting a winning block from one of the blocks in the triangular display; comparing the winning block to the one or more of the blocks selected by the player; and awarding winnings to the player if the winning block is among the one or more of the blocks selected thereby.

In still another aspect, this invention includes a gaming machine. The gaming machine includes a triangular display including rows and blocks, the triangular display including at least three of the rows and at least nine of the blocks; each of the blocks configured for displaying one of a set of characters, each one of the set of characters being selected from the group consisting of alpha-numeric indicia, symbols, trademarks, pictures, and images. The gaming machine is a member of the group consisting of a video gaming machine and a vertical wheeled-slot machine.

In a further aspect, this invention includes a method of playing a matching game. The method includes: a) providing a plurality of game sheets having at least one triangular display, the at least one triangular display including rows and blocks, the number of rows being in the range from five to ten and the number of blocks being in the range from 15 to 55; each of the blocks including one of a set of characters disposed thereon, the set of characters being selected from the group consisting of alpha-numeric indicia, symbols, trademarks, pictures, and images. The method further includes: b) distributing the plurality of game sheets to a plurality of players; c) generating a random number representative of one of the set of characters; d) communicating the one of the set of characters to the plurality of players; e) repeating c) and d) until at least one of the plurality of players fills in a predetermined pattern of the blocks on the at least one triangular display; and f) awarding winnings to the at least one of the plurality of players.

### BRIEF DESCRIPTION OF THE DRAWINGS

FIG. 1 is a block diagram of one embodiment of a game of the present invention;

FIG. 2 is a representation of one embodiment of a triangular display used in the game of FIG. 1;

FIG. 3 is a representation of another embodiment of a triangular display used in the game of FIG. 1;

FIG. 4A is a representation of one embodiment of a game table, including the triangular display of FIG. 2, that may be used in the game of FIG. 1;

FIG. 4B is a representation of an alternate embodiment of a game table, including the triangular display of FIG. 2, that may be used in the game of FIG. 1;

FIG. 4C is a representation of a portion of the game table of FIG. 4B;

FIG. 5 is a perspective view of a pyramid display including triangular display of FIG. 3, that may be used in the game of FIG. 1;

FIG. 6 is a representation of a portion of the gaming table shown in FIG. 4A having bets placed thereon;

FIG. 7 is a representation of a yet another embodiment of a triangular display that may be used in the game of FIG. 1;

FIG. 8 is a representation of another embodiment of a game table that may be used in the game of FIG. 1;

FIG. 9 is a schematic representation of still another embodiment of a triangular display;

FIG. 10 is schematic representation of a game sheet including the triangular display of FIG. 9;

FIG. 11 is a perspective view of one embodiment of a gaming machine including a triangular display;

FIG. 12 is a top view of a cluster of gaming machines each having a triangular display; and

FIG. 13 is a schematic representation of the triangular display of FIG. 11.

### DETAILED DESCRIPTION

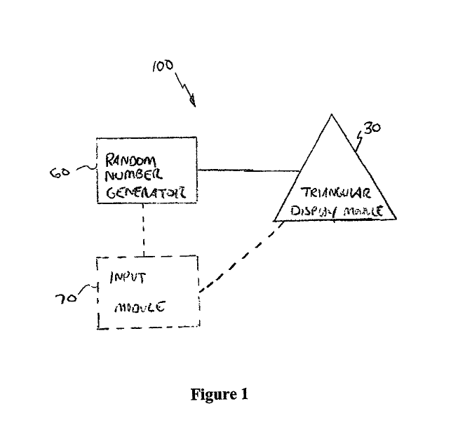

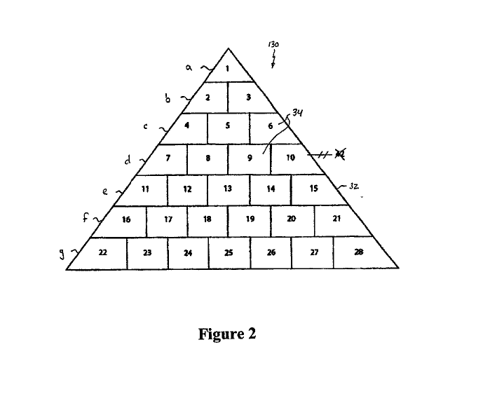

Referring to FIG. 1., embodiments of the present invention include a game of chance 100 having a random number generator 60, a triangular display 30 having a plurality of rows 32 and blocks 34 (see FIG. 2), and optional means for receiving a wager (e.g., input means or input module) 70. In one embodiment of the game, players select (or place bets on) one or more blocks 34 or groups of blocks 34 in the triangular display 30 using means 70. The random number generator 60 then generates a random number, which is used to designate a winning block. If the winning block is among those selected or within the group selected by the player, the player wins. Otherwise the player loses. In another embodiment, the game of this invention is configured as a gaming machine, having a triangular display 30. In still another embodiment, the game of this invention is a matching game having a triangular display 30. The artisan of ordinary skill will readily recognize that the game of this invention may be played at one or more casinos, at on-line casinos (web based casinos), lotteries, and the like. Potential advantages of this invention are described hereinafter in a discussion of various embodiments thereof.

Referring again to FIG. 1, random number generator 60 typically includes a computer processor, but may also include dice, cards, wheels, balls, and/or other known implements for generating random numbers. As used herein, the term computer processor generally refers to any suitable processing device including a programmable digital computer, microprocessor, microcontroller, etc., including dedicated, embedded and general computers, and the like. Means 70 may include substantially any known (or yet to be developed) means suitable for receiving a wager. For example, means 70 may include an input module such as a touch screen, an electronic keypad, a keyboard, a wireless device, a pointing device (e.g., a mouse or trackball), and/or a coin/chip acceptor. Alternatively, means 70 may include a game piece such as a coin, a chip, a coupon, monetary currency, a token, a voucher, and the like, which may be used to designate a wager (e.g., by placement on one or more of the blocks 34 of triangular display 30).

Referring now to FIG. 2, one embodiment of a triangular display 30, for use in embodiments of the game of chance 100 of the present invention is shown. Triangular display 130 may include any number of rows 32 and blocks 34, however, typically includes at least 3 rows 32 and at least 6 blocks 34. Triangular display 130 desirably includes greater than or equal to about 5 and less than or equal to about 10 rows 32 and greater than or equal to about 15 to less than or equal to about 55 blocks 34. For example, the desirable triangular display 130 shown in FIG. 2 includes 7 rows 32 and 28 blocks 34. The triangular display 130 is typically, but not necessarily, configured to include one block in the first row a (i.e., the top row in FIG. 1), two blocks in the second row b, three blocks in the third row c, and so on until the nth row, which typically includes n blocks (e.g., row g includes 7 blocks in the display of FIG. 2).

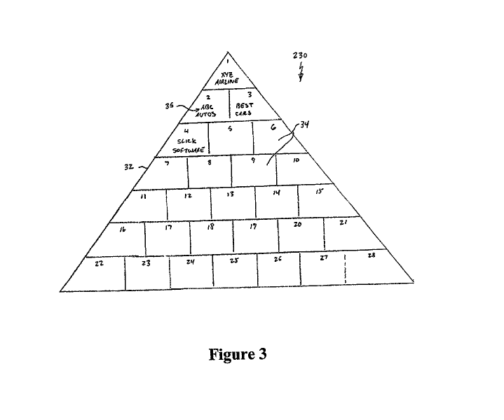

Triangular display 130 may include substantially any markings, such as alphanumeric indicia. For example, as shown in FIG. 2, blocks 34 of display 130 may simply be numbered from 1 to n (e.g., 28 as shown in FIG. 2). Alternatively and/or additionally, rows 32 may be colored for providing visual distinction. In one desirable embodiment, shown in FIG. 3, triangular display 230 includes alphanumeric indicia 35 representative of various stocks (e.g., names and/or trademarks of publicly traded companies) and/or stock ticker symbols. For example, in FIG. 3, block 1 includes reference to “XYZ Airlines”, while block 2 includes reference to “ABC Autos”. Likewise, although not shown for each of the blocks in the Figure, blocks 3-28 may also include substantially any markings, such as alpha-numeric indicia, trademarks, and/or ticker symbols representative of various publicly traded companies. In a further desirable embodiment, each row 32 of display 230 includes indicia 35 representative of companies of a particular industrial sector. For example, as shown in FIG. 3, the first row (including block 1) may include stocks from the airline sector, the second row (including blocks 2 and 3) may include stocks from the automobile-manufacturing sector, the third row (including blocks 4, 5 and 6) may include stocks from the computer software sector, and so forth. Display 230 may further include numbers, colors, and/or other markings as described hereinabove. The artisan of ordinary skill will readily recognize that triangular display 130 may also include markings indicative of private companies (i.e., those not traded on public stock exchanges). The ordinarily skilled artisan will also readily recognize that triangular display 230 may be modified to include images of people, characters, real estate, famous places and the like or alphanumeric indicia representative of various themes, such as sports teams, famous athletes, names of celebrities, names of cities, kinds of food, and the like in place of the company names (e.g., stocks) shown in FIG. 3.

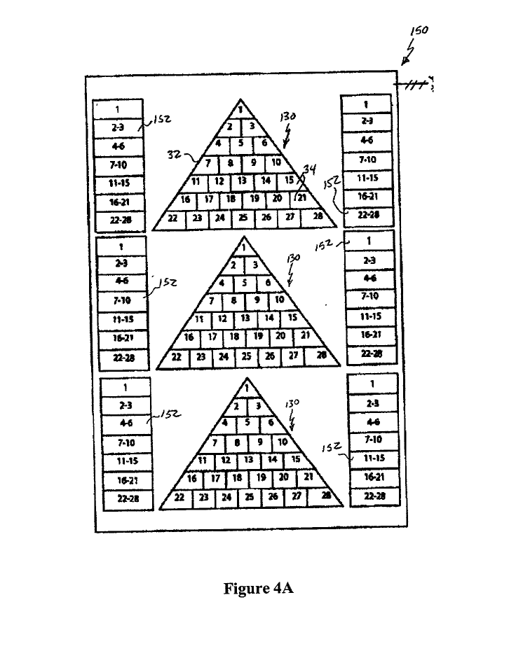

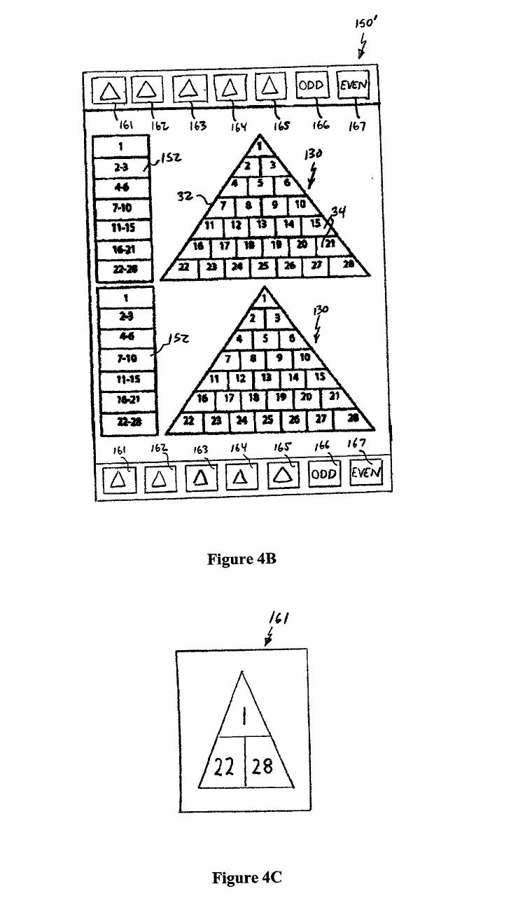

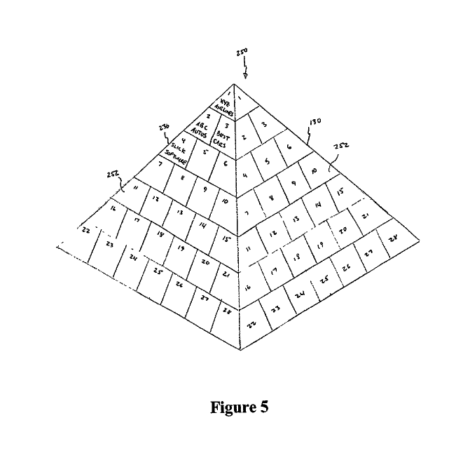

Triangular display 30, 130, 230 may be presented on substantially any playing station. For example, in one embodiment, display 30, 130, 230 is included on a computerized display (e.g., a graphical user interface (GUI)). In an alternate embodiment, a gaming table 150, such as shown in FIGS. 4A & 6, may include one or more triangular displays 30, 130, 230 (for example as shown in FIGS. 2 and 3). Gaming table 150 desirably further includes row selector blocks 152 that indicate the group of blocks 34 included in each row 32 of triangle display 30, 130, 230. In another embodiment, such as shown in FIG. 4B, a gaming table 150′ may include any number of group selector blocks 161, 162, 163, 164, 165, 166, 167 that indicate additional groupings of blocks 34 upon which wagers may be placed. In one exemplary embodiment of gaming table 150′, group selector block 161 includes comer blocks 1, 22, and 28 (as shown in FIG. 4C), group selector block 162 includes a sub-triangle including blocks 1, 2, 3, 4, 5, and 6, group selector block 163 includes a sub-triangle including blocks 1, 2, 3, 4, 5, 6, 7, 8, 9, and 10, group selector block 164 includes right side blocks 1, 3, 6, 10, 15, 21, and 28, group selector block 165 includes left side blocks 1, 2, 4, 7, 11, 16, and 22, group selector block 166 includes odd numbered blocks, and group selector block 167 includes even numbered blocks. Group selector block 161 is shown in FIG. 4C for illustrative purposes. The artisan of ordinary skill will readily recognize that gaming table 150′ may include substantially any number of group selector blocks, each including substantially any combination of blocks 34.

In yet another embodiment, shown in FIG. 5, a display pyramid 250 includes one or more triangular displays 30, 130, 230 on faces thereof. Display pyramid 250 typically includes three or four triangular faces 252, each of which includes a single triangular display 30, 130, 230. In a desirable embodiment, display pyramid 250 includes triangular display 230 (having markings representative of various publicly traded companies) on each of its three or four sides 252 and is positioned (i.e., displayed) prominently above the playing area to attract players to the game. This desirable embodiment of pyramid 250 may also be referred to as a “pyramid of stocks”.

Referring again to FIG. 2, in embodiments of this invention, a player (or players) place wagers on one or more blocks or groups of blocks displayed in triangular display 30, 130, 230 using any suitable means 70. Bets may typically be placed on one or more individual blocks or on one or more groups of blocks. The groups of blocks may be selected in substantially any way, but are typically selected using the geometric factors of the triangular display 30, 130, 230. For example, a player may select a row of blocks or two rows of blocks (or a sector or two sectors of stocks as shown in FIG. 3). Triangular display 130 (FIG. 2) includes seven rows 32, referred to as rows a, b, c, d, e, f, and g, each of which includes a different number of blocks, as follows:

Row a (block 1)

Row b (blocks 2-3)

Row c (blocks 4-6)

Row d (blocks 7-10)

Row e (blocks 11-15)

Row f (blocks 16-21)

Row g (blocks 22-28)

Alternately, a player may bet on a group that consists of a sub-triangle including three, six or more blocks (depending upon the number of rows 32 in the triangular display 30, 130, 230). For example triangular display 130 (FIG. 2) includes 21 upright sub-triangles and 15 upside-down sub-triangles, each having three blocks, as follows:

Sub-triangle 1 (blocks 1,2,3)

Sub-triangle 2 (blocks 2,4,5)

Sub-triangle 3 (blocks 3,5,6)

Sub-triangle 4 (blocks 4,7,8)

Sub-triangle 5 (blocks 5,8,9)

Sub-triangle 6 (blocks 6,9,10)

Sub-triangle 7 (blocks 7,11,12)

Sub-triangle 8 (blocks 8,12,13)

Sub-triangle 9 (blocks 9,13,14)

Sub-triangle 10 (blocks 10,14,15)

Sub-triangle 11 (blocks 11,16,17)

Sub-triangle 12 (blocks 12,17,18)

Sub-triangle 13 (blocks 13,18,19)

Sub-triangle 14 (blocks 14,19,20)

Sub-triangle 15 (blocks 15,20,21)

Sub-triangle 16 (blocks 16,22,23)

Sub-triangle 17 (blocks 17,23,24)

Sub-triangle 18 (blocks 18,24,25)

Sub-triangle 19 (blocks 19,25,26)

Sub-triangle 20 (blocks 20,26,27)

Sub-triangle 21 (blocks 21,27,28)

Sub-triangle 22 (blocks 2,3,5)

Sub-triangle 23 (blocks 4,5,8)

Sub-triangle 24 (blocks 5,6,9)

Sub-triangle 25 (blocks 7,8,12)

Sub-triangle 26 (blocks 8,9,13)

Sub-triangle 27 (blocks 9,10,14)

Sub-triangle 28 (blocks 11,12,17)

Sub-triangle 29 (blocks 12,13,18)

Sub-triangle 30 (blocks 13,14,19)

Sub-triangle 31 (blocks 14,15,20)

Sub-triangle 32 (blocks 16,17,23)

Sub-triangle 33 (blocks 17,18,24)

Sub-triangle 34 (blocks 18,19,25)

Sub-triangle 35 (blocks 19,20,26)

Sub-triangle 36 (blocks 20,21,27)

The combinations of groups upon which a player may place bets are essentially unlimited, which is potentially advantageous in that it adds substantial variety to the number and types of bets that may be placed and therefore may appeal to players who become easily bored with the repetition associated with other games of chance (e.g., roulette). Additionally, depending upon the group or groups selected, players may place bets having a wide range of odds (i.e., winning percentage). For example, a player preferring relatively large payouts at relatively low odds may select a single block (or stock). Conversely, a player preferring relatively high odds (e.g., at relatively low payouts) may select a group of blocks including substantially all of the odd or even numbered blocks. Alternately, a player preferring medium odds may select a group of blocks (e.g., row g in FIG. 2 described hereinabove). Examples of other groups include, but are not limited to: the corner blocks (e.g., blocks 1, 22, and 28 in FIG. 2), corner blocks of sub-triangles having six or more blocks (e.g., blocks 1, 4, and 6 or blocks 1, 7, and 10 in FIG. 2), right side blocks (e.g., blocks 1, 3, 6, 10, 15, 21, and 28 in FIG. 2), left side blocks (e.g., blocks 1, 2, 4, 7, 11, 16, 22 in FIG. 2), even numbered blocks, odd numbered blocks, two or more diagonally adjacent blocks (e.g., blocks 8 and 13 or blocks 4, 8, 13, and 19 in FIG. 2), two or more blocks in a row (e.g., blocks 8 and 10 or blocks 17, 19, and 20 in FIG. 2), and the like. The artisan of ordinary skill will readily recognize that one or more blocks 34 (e.g., block number 1) may be designated as ‘house blocks’, i.e., blocks on which players may not wager, thereby creating a house advantage. Alternatively, the odds of winning and/or the size of any payouts may be set to provide a house advantage.

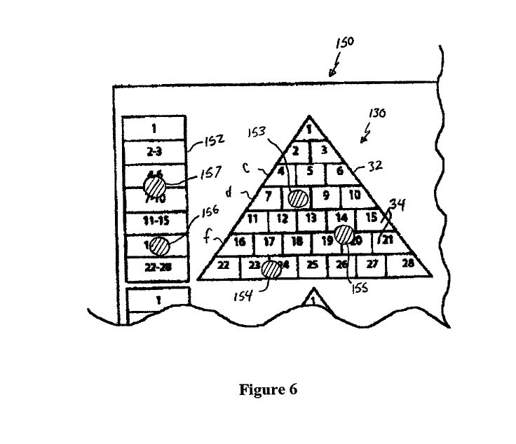

One desirable embodiment of this invention includes a table game played at a gaming table 150, 150′ (such as that shown in FIGS. 4A, 4B & 6) and the players wager by an input means 70 which may include placing one or more game pieces (e.g., chips, coins or tokens) on the block or blocks of interest. For example, in FIG. 6, a portion of gaming table 150 is shown having five exemplary bets (using chips 153, 154, 155, 156, 157) placed thereon. As shown, chip 153 is placed on block number 8 and is representative of a bet placed on a single block 34. Chip 154 is placed on block numbers 23 and 24 and is representative of a bet placed on adjacent blocks. Chip 155 is placed on block numbers 14, 19 and 20 and is representative of a bet placed on a subtriangle including the aforementioned blocks. Chip 156 is placed on a row selector block 152 indicating a bet on a row 32 (i.e., row f) of blocks 34 (i.e., block numbers 16, 17, 18, 19, 20 and 21). Chip 157 is placed over a portion of each of two row selector blocks 152 indicating a bet on two rows 32 (i.e., rows c and d) of blocks 34 (i.e., block numbers 4, 5, 6, 7, 8, 9, and 10).

The table game of this invention is further advantageous in that it may be readily configured as a progressive game. For example, a player who wins two or more times consecutively on the same block may win a prize or a relatively larger payout. For example, a player who wins consecutive games with a bet on “XYZ Airlines” (FIG. 3) may, in addition to the normal winnings, win a travel coupon. Further, the progressive game may be tailored to the betting preferences of an individual player. For example, for a player that prefers winning relatively frequently (and is therefore willing to accept a smaller payout) the progressive game may include consecutive wins on a group having four blocks (odds of about 50:1 for display 130 shown in FIG. 2). Alternatively, for a player that prefers relatively high payouts (and therefore at relatively lower odds), the progressive game may include three consecutive wins on a single block (odds of about 22,000:1 for display 130 shown in FIG. 2).

Alternatively (and/or additionally), a progressive game may include generating a second random number. In this game, a player typically places two bets; a first bet on a block 34 or group of blocks (e.g., from triangular display 130), and a second, progressive bet. The second bet may be substantially any bet, but is typically thematically related to the game. For example, in a pyramid of stock game, the first bet may be on a stock or group of stocks and the second may be selecting a closing value for the stock market (e.g., a randomly generated integer between 8,000 and 14,000) or the amount that the stock market will increase in a give period of time (e.g., a randomly generated integer between 1 and 1000). Upon receiving the bets, the game manager (e.g., the dealer) will activate processor 60 to generate the random numbers. Players may win neither, either, or both of their bets. Players winning both bets simultaneously may optionally receive a bonus payout.

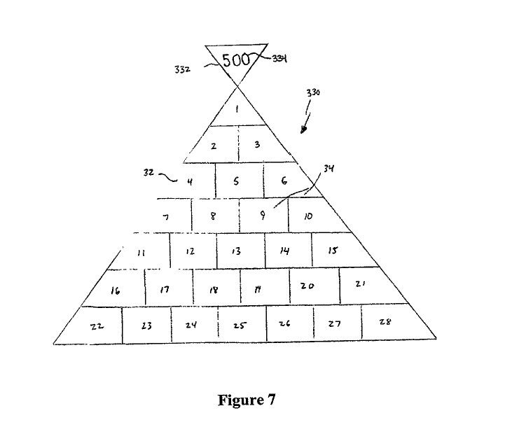

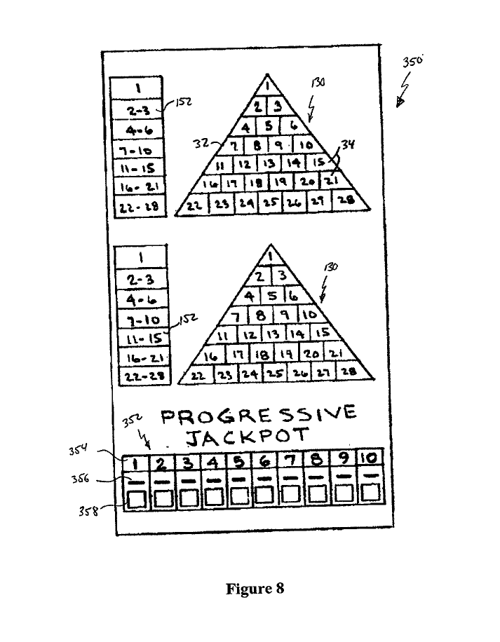

Referring now to FIG. 7, an embodiment of a triangular display 330 for use with one embodiment of a progressive game is illustrated. Triangular display 330 is substantially identical to triangular display 130 (FIG. 2) with the exception that it includes an electronic display 332 (in the form of an upside down triangle) at the top thereof for displaying a winning progressive number 334. Display 330 may optionally include another electronic display (not shown) for highlighting the dollar amount of a progressive jackpot (e.g., paid out to a player who simultaneously wins both bets described in the preceding paragraph). In the absence of a winner, the amount (i.e., payout) of the progressive jackpot may increase. This amount may continue to increase in proportion to the number of non-winning bets placed, until a winner is determined, at which time the payout amount will return to a starting value. Referring to FIG. 8, an embodiment of gaming table 350 for use in a progressive game is shown. Gaming table 350 is similar to gaming table 150 in that it includes one or more triangular displays 130 and graphics 152 that indicate the groups of blocks 34 in each row 32. Gaming table 350 further includes a progressive game section 352 having markings 354 indicative of the player number, coin/chip acceptors 356, and number selector display 358 for selecting a progressive wager.

The progressive games described hereinabove, may also be readily applied to other games of chance, such as the games of roulette or video roulette. For example, in one embodiment, a player who wins two or more games consecutively on the same number or group of numbers (e.g., color) while playing the game of roulette or video roulette may win a prize or a relatively larger payout. Alternatively (and/or additionally), a player may place an optional, progressive wager while playing a game of roulette. The second bet may be substantially any bet, but is typically thematically related to the game. For example, a random number generator (e.g., such as random number generator 60) may generate a random number, e.g., from between about 1 to about 5,000. Alternatively, a roulette wheel (or simulated roulette wheel for video roulette) may include an outer race for randomly selecting a progressive number. Players may win neither, either, or both of their bets. Players winning both bets simultaneously may optionally receive a bonus payout.

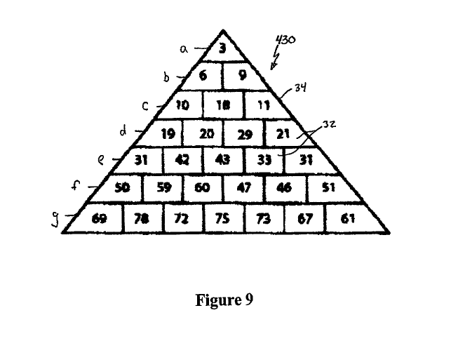

Referring now to FIG. 9, a triangular display 430 for use in a matching game is shown. Triangular display 430 is comparable to the triangular displays 130, 230 discussed hereinabove in that it includes a plurality of rows 32 and a multiplicity of blocks 34. As with a conventional matching game board, each block includes a character (e.g., a number, letter, word, picture, symbol, image, or trademark). In one embodiment, the blocks include numbers and are numbered as follows:

The block in row a includes a number in the range from 1 to 3;

the blocks in row b each include a number in the range from 4 to 9;

the blocks in row c each include a number in the range from 10 to 18;

the blocks in row d each include a number in the range from 19 to 29;

the blocks in row e each include a number in the range from 30 to 43;

the blocks in row f each include a number in the range from 44 to 60; and

the blocks in row g each include a number in the range from 61 to 80.

Further, the rows a, b, c, d, e, f, g are typically labeled with markings indicating a stock market sector, a company name, and/or the like (e.g., as described hereinabove with respect to triangular displays 130, 230).

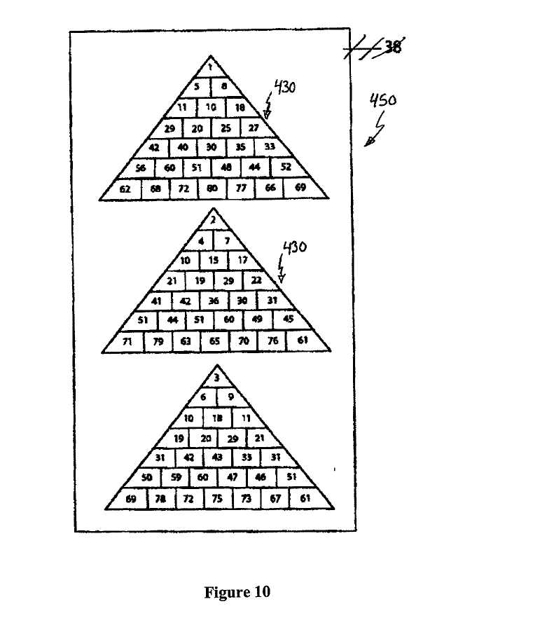

Players are typically located at playing stations (e.g., local or remote computers) or in a room similar to that of a bingo hall. Each player typically purchases (or receives or downloads) one or more play sheets (e.g., play sheet 450 shown in FIG. 10) from the house. A random number generator 60 then randomly generates an integer value ranging from 1 to 80. A game manager (e.g., a dealer) may call out or transmit the number or the row and number (e.g., “airlines two”). Players then fill the block(s) 34 (e.g., by selecting with a mouse, or covering with a coin or some other game piece) on their game sheets 450 having the corresponding number. Play typically continues until one or more players fill in a predetermined row or pattern on at least one of the triangular displays 430 on their game sheet 450. These players are declared winners and may receive a prize or payout.

In alternate embodiments, players purchase individual games (e.g., including a video display of triangular display 430) at a gaming machine, such as at a video game terminal. The matching game is typically played in a manner similar to that described above. A random number generator 60 randomly generates a first integer value ranging from 1 to 80. The gaming machine then typically fills the appropriate block on the triangular display 430. The random number generator 60 then generates (either automatically or by player activation) another integer value ranging from 1 to 80. The game typically continues until a predetermined row or pattern is filled on the players (or the gaming machine's) triangular display. In one embodiment, the player plays against the gaming machine. If a predetermined row or pattern is filled on the player's triangular display 430 prior to the same row or pattern being filled on the game machine's triangular display 430, then the player wins and receives an optional payout. In another embodiment, play continues until a predetermined row or pattern is filled on the player's triangular display. If the predetermined row or pattern is filled using less than a critical number of randomly generated numbers, then the player wins. For example, if only five random numbers are required to fill row e (having five blocks), then the player may win the maximum payout. Alternatively, if ten random numbers are required, the player may win a relatively smaller payout. If twelve random numbers are required, the player may lose and receive no payout.

The matching game of this invention is potentially advantageous over conventional bingo in that the triangular display provides for a wide range of winning patterns, some of which include a relatively small number of blocks (e.g., three), others of which include a relatively large number of blocks (e.g., eighteen or more). This is advantageous in that the approximate duration of the games may be tailored to the interest of the players (i.e., winning patterns having a relatively small number of blocks will tend to result in games of relatively short duration while winning patterns having a relatively large number of blocks will tend to result in games of relatively longer duration). Examples of winning patterns include:

Fill all of the blocks in rows a and b;

fill all of the blocks in row c;

fill all of the blocks in row d;

fill all of the blocks in row e;

fill all of the blocks in row f;

fill all of the blocks in row g;

fill all of the blocks in rows a, b, and c;

fill all of the blocks in rows a, b, c, and d;

fill all of the blocks in rows a, b, c, d, and e;

fill all of the blocks in rows a, b, c, d, e, and f;

fill all of the blocks in rows a, b, c, d, e, f, and g;

fill all of the triangle corner blocks;

fill all of the right side blocks;

fill all of the left side blocks;

fill all of the blocks in rows c, d, and e;

fill all of the blocks in rows e and f;

fill all of the blocks in rows f and g;

fill all of the blocks in the perimeter locations of the triangle; and

fill all of the blocks in the interior locations of the triangle.

The artisan of ordinary skill will readily recognize that substantially any pattern of blocks 34 may be designated as a winning pattern. The ordinarily skilled artisan will also readily recognize that while a triangular display 430 having seven rows 32 and 28 blocks 34 is shown in FIGS. 9 and 10, triangular displays having substantially any number of rows 32 and blocks 34 may be used.

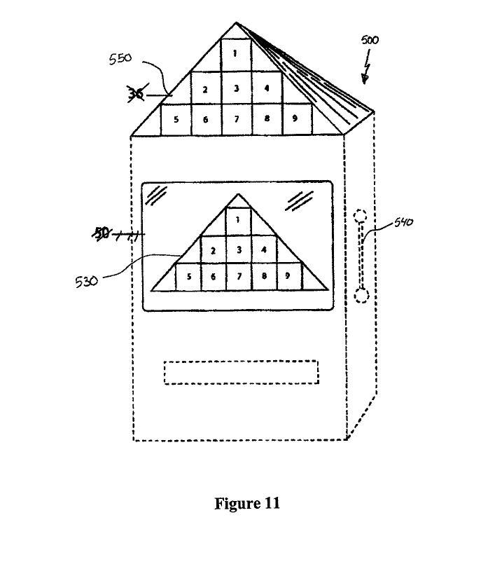

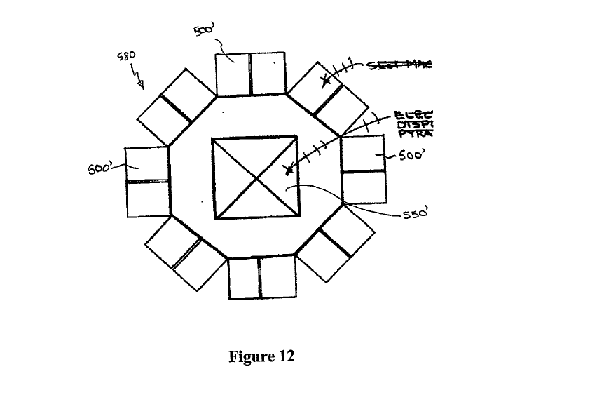

Referring now to FIG. 11, a further embodiment of the present invention includes a gaming machine 500 having a triangular display 530. Gaming machine 500 may also optionally include a pyramidal display 550 (e.g., a pyramid of stocks) on the top thereof or be clustered around a central pyramidal display 550′ (FIG. 12) to attract players to the game.

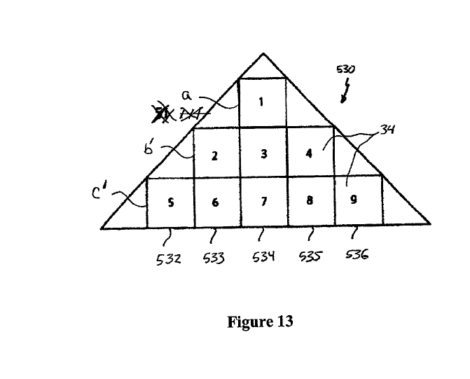

Referring now to FIG. 13, triangular display 530 typically includes three rows a, b′, c′ and five columns 532, 533, 534, 535, 536. As described hereinabove, each block 34 may include any markings, such as alphanumeric indicia, symbols, pictures, images and the like indicative of stocks, celebrities, sports teams, and the like. Triangular display 530 may be of any type used in conventional slot machines, such as video or reel-type format. When using a reel-type format, triangular display typically includes five reels, one for each of columns 532, 533, 534, 535, and 536. To place a bet, a player typically inserts one or more coins (or tokens) and pulls arm 540 (FIG. 11), which sets the reels in a spinning motion (as in a conventional slot machine which are known to those of ordinary skill in the art). The reels typically stop one at a time from left to right (i.e. from column 532 to column 536) as follows:

The first reel (i.e., column 532) stops and displays block 5;

the second reel (i.e., column 533) stops and displays blocks 2 and 6;

the third reel (i.e., column 534) stops and displays blocks 1, 3, and 7;

the fourth reel (i.e., column 535) stops and displays blocks 4 and 8; and

the fifth reel (i.e., column 536) stops and displays block 9.

A variation of this embodiment, in electronic or video format, is typically programmed to simulate the above described action of a reel-type format, however may be programmed to display the individual blocks 34 of display 530 in substantially any manner, such as randomly, sequentially, by row, by column, and the like. A player typically wins when a predetermined number or pattern of a particular alphanumeric indicia, symbol, picture, image, and the like is displayed on triangular display 530. Examples of winning combinations include:

Three of a kind;

Four of a kind;

Five of a kind;

Three of a kind all located in row b,

Three of a kind located at corners (i.e., blocks 1, 5, and 9);

Three of a kind located in row c;

Four of a kind located in row c; and

Five of a kind located in row c;

Gaming machine 500 may also be readily configured as a progressive game. For example, in typical embodiment a player may wager from one to five coins (or tokens). A player wagering five coins is automatically entered into a progressive game in which the gaming machines are programmed to generate random progressive jackpot winners.

The games of this invention, including one or more of the triangular displays described hereinabove, may be particularly advantageous in that commercial advertising may be readily integrated therein. For example, triangular display 230 (FIG. 3) includes names of actual companies (i.e., stocks), which allows players to relate to these companies while playing the games of this invention. Blocks 34 may be thought of as miniature billboards and sold as such. Further, the prominence of the pyramid displays 250, 550 and 550′, for example, typically provides for a highly visible medium for any advertising disposed thereon. Further still, in keeping with the stock market motif of one aspect of this invention, advertising may also be integrated into a scrolling display (a stock ticker) as is commonly used to display price information for individual stocks.

Additionally, and as described briefly above, promotional merchandise may be included into a player's winnings. For example, a player winning one or more times, consecutively or cumulatively, with bets on XYZ airlines (for example) may win coupons for discounted travel on that airline. Coupons for discounted merchandise or services may be provided for substantially any company within substantially any industry such as computer hardware, software, automobile, transportation, insurance, beverage, fast food, and the like.

The modifications to the various aspects of the present invention described hereinabove are merely exemplary. It is understood that other modifications to the illustrative embodiments will readily occur to persons with ordinary skill in the art. All such modifications and variations are deemed to be within the scope and spirit of the present invention as defined by the accompanying claims.

What is claimed is:

1. A display for a game of chance, said display comprising:
at least one triangular display section, each of which includes:
at least three rows;
at least six blocks, each of said blocks including markings;
wherein said game of chance is selected from the group consisting of a table game, a matching game, vertical reeled slots, and a video game.

2. The display of claim 1 including from about five to about 10 rows and from about 15 to about 55 blocks.

3. The display of claim 1 wherein said markings are selected from the group consisting of images, pictures, symbols, alpha-numeric indicia, trademarks, and colors.

4. The display of claim 3 wherein said markings are representative of a plurality of publicly traded companies, each of said blocks having markings representative of a unique one of said plurality of publicly traded companies.

5. The display of claim 4 wherein said markings include stock ticker symbols.

6. The display of claim 1 further comprising a graphical user interface, said triangular display section being displayed thereon.

7. The display of claim 1 comprising at least two of said triangular display sections.

8. The display of claim 1 further comprising a plurality of row selector blocks disposed substantially adjacent to said rows.

9. The display of claim 1 comprising three of said triangular display sections.

10. The display of claim 1 further comprising a pyramidal display including at least three sides, each of said at least three sides having one of said triangular display sections disposed thereon.

11. The display of claim 1 further comprising an input module for receiving a wager, said input module being selected from the group consisting of a touch screen, a touch pad, a keypad, a keyboard, a coin/chip acceptor, and a pointer.

12. The display of claim 1 wherein said game of chance comprises a table game wherein:
a player selects one or more of said blocks in said at least one triangular display section;
a winning one of said blocks in said at least one triangular display is randomly selected using a random number generator; and
the player wins if the winning one of said blocks is among said one or more of said blocks selected by the player.

13. A game of chance comprising:
a triangular display including rows and blocks, said triangular display including at least three of said rows and at least six of said blocks, each of said blocks including markings;
a selecting module configured to randomly select at least one winning block from said blocks in said triangular display; and
means for receiving a wager on one or more of said blocks in said triangular display.

14. The game of claim 13 wherein said means for receiving a wager comprises an input module selected from the group consisting of a touch screen, a keyboard, a keypad, a pointing device, a coin/chip acceptor and a wireless device.

15. The game of claim 13 wherein said means for receiving a wager comprises at least one game piece configured for being placed over a portion of said triangular display.

16. The game of claim 15 wherein said at least one game piece is selected from the group consisting of coins, paper currency, chips, tokens, vouchers, coupons, and combinations thereof.

17. The game of claim 13 wherein said selecting module comprises a random number generator selected from the group consisting of a computer processor, dice, cards, wheels, reels, balls, and combinations thereof.

18. The game of claim 17 wherein said random number generator comprises a computer processor.

19. The game of claim 13 wherein said triangular display comprises seven rows and twenty eight blocks.

20. The game of claim 13 wherein said markings are representative of a plurality of publicly traded companies, each of said blocks having markings representative of a unique one of said plurality of publicly traded companies.

21. A method of playing a game of chance comprising:
providing a triangular display including rows and blocks, the triangular display including at least three of the rows and at least six of the blocks;
receiving a wager from a player on one or more of the blocks;
randomly selecting a winning block from one of the blocks in the triangular display;
comparing the winning block to the one or more of the blocks selected by the player; and
awarding winnings to the player if the winning block is among the one or more of the blocks selected thereby.

22. The method of claim 21 wherein:
the number of the rows in the triangular display is in the range from five to ten; and
the number of the blocks in the triangular display is in the range from 15 to 55.

23. The method of claim 21 wherein the triangular display includes seven of the rows and 28 of the blocks;

24. The method of claim 21 wherein said markings are representative of a plurality of publicly traded companies, each of said blocks having markings representative of a unique one of said plurality of publicly traded companies.

25. The method of claim 21 wherein said receiving a wager comprises receiving a wager on a single one of the blocks.

26. The method of claim 21 wherein said receiving a wager comprises receiving a wager on a group of the blocks.

27. The method of claim 26 wherein the group of the blocks is selected from the group consisting of: two adjacent blocks, three adjacent blocks, four adjacent blocks, a sub-triangle having three blocks, a sub-triangle having six blocks, a sub-triangle having ten blocks, a row of blocks, two rows of blocks, two blocks in a single row, three blocks in single row, four blocks in single row, a side of blocks; three comer blocks; odd numbered blocks, even numbered blocks, and combinations thereof.

28. The method of claim 21 wherein at least one of the blocks in the triangular display is a house block upon which no wagers may be received.

29. The method of claim 21 wherein said receiving a wager from a player comprises:
the player placing a game piece over at least a portion of the one or more of the blocks upon which the wager is placed;
wherein the one or more of the blocks is selected from the group consisting of a single block, two adjacent blocks, and a sub-triangle having three blocks.

30. The method of claim 21 wherein said receiving a wager from a player comprises:
the player placing a game piece over at least a portion of a row selector block disposed substantially adjacent to one of said rows;
wherein the one or more of the blocks is selected from the group consisting of one row of blocks and two rows of blocks.

31. The method of claim 21 wherein said receiving a wager from a player comprises:
the player placing a game piece over at least a portion of a group selector block disposed in proximity to the triangular display;
wherein the one or more of the blocks is selected from the group consisting of corner blocks, left side blocks, right side blocks, a sub-triangle including six blocks, a sub-triangle including ten blocks, odd numbered blocks and even numbered blocks.

32. The method of claim 21 wherein said randomly selecting comprises generating a random number corresponding to one of the blocks in the triangular display.

33. The method of claim 21 wherein:
the blocks include markings representative of a plurality of publicly traded companies; and
said method further comprises receiving advertising revenue from at least one of the publicly traded companies in exchange for disposing markings representative of the at least one of the publicly traded companies on at least one of the blocks.

34. The method of claim 21 wherein:
said receiving a wager from a player on one or more of the blocks includes receiving a wager on the one or more of the blocks of at least two consecutive games, a first game and a second game; and
said method further comprises awarding additional winnings to the player if the winning block for the first game and the winning block for the second game are among the one or more of the blocks selected thereby.

35. The method of claim 34 wherein the one or more of the blocks is a single block;

36. The method of claim 35 wherein:
the single block includes markings representative of a publicly traded company; and
wherein the additional winnings include promotional merchandise from the publicly traded company.

37. The method of claim 21 further comprising:
receiving an other wager from a player, the other wager being placed on one or more progressive jackpot numbers;
randomly selecting a winning progressive jackpot number;
comparing the winning progressive jackpot number to the one or more progressive jackpot numbers; and
awarding winnings to the player if the winning progressive jackpot number matches the one or more progressive jackpot numbers.

38. The method of claim 37 further comprising:
awarding bonus winnings to the player if:
the winning block is among the one or more of the blocks selected thereby; and
the winning progressive jackpot number matches the one or more progressive jackpot numbers.

39. A gaming machine comprising:
a triangular display including rows and blocks, said triangular display including at least three rows and at least nine blocks; each of said blocks configured for displaying one of a set of characters, each one of said set of characters being selected from the group consisting of alphanumeric indicia, symbols, trademarks, pictures, and images.
wherein said gaming machine is member of the group consisting of a video machine and a vertical wheeled-slot machine.

40. The gaming machine of claim 39 further comprising a pyramid display disposed thereon, said pyramid display including at least three sides, at least one of said at least three sides including an other triangular display having rows and blocks.

41. The gaming machine of claim 39 wherein said set of characters is representative of a set of publicly traded companies, each one of said set of characters being representative of one of said set of publicly traded companies.

42. The gaming machine of claim 39 comprising three of said rows and nine of said blocks.

43. The gaming machine of claim 39 comprising five vertical reels.

44. The gaming machine of claim 39 wherein said slot machine is a video machine.

45. A method of playing a matching game comprising:
a) providing at least one game sheet having at least one triangular display, each of said at least one triangular display including rows and blocks, the number of rows being in the range from five to ten and the number of blocks being in the range from 15 to 55; each of the blocks including one of a set of characters disposed thereon, said set of characters selected from the group consisting of alpha-numeric indicia, symbols, trademarks, and images;
b) distributing the at least one game sheet to at least one player;
c) generating a random number representative of one of the set of characters;
d) communicating the one of the set of characters to the at least one player; and
e) repeating c) and d) until the at least one player fills in a predetermined pattern of the blocks on the at least one triangular display.

46. The method of claim 45 further comprising:
f) awarding winnings to the at least one player.

47. The method of claim 45 wherein:
the at least one player includes one player playing against a computer; and
the game sheet is displayed on a graphical user interface (GUI).

48. The method of claim 47 further comprising:
f) awarding winnings to the one player playing against the computer if the predetermined pattern is filled on the player's game sheet prior to the predetermined pattern being filled on the computer's game sheet.

49. The method of claim 47 wherein said repeating includes repeating c) and d) until a predetermined pattern of blocks is filled on the triangular display or until a set number of iterations has been reached; and
said method further comprising f) awarding winnings to the one player playing against the computer when the predetermined pattern is filled in less than the set number of iterations.

50. The method of claim 45 wherein the rows of the at least one triangular display are labeled with a member of the group consisting of alphanumeric indicia, symbols, pictures, images, and colors.

51. The method of claim 50 wherein said communicating comprises calling out the label and the character.

52. The method of claim 45 wherein the predetermined pattern is selected from the group consisting of each of the blocks in a single row, each of the blocks in two rows, each of the blocks in three rows, each of the blocks in four rows, each of the blocks at the periphery of the at least one triangular display, each of the blocks in the interior of the at least one triangular display.

53. A method of playing progressive roulette comprising:
providing a roulette game;
receiving a first wager on a first game from a player, the first wager being on a number in the roulette game;
receiving a second wager on a second game from the player, the second wager being on the same number as the first wager; the first game and the second game being consecutive games;
randomly selecting a winning number for the first game and a winning number for the second game;
comparing the winning number for the first game and the winning number for the second game to the number wagered on by the player;
awarding winnings to the player if the number waged on by the player matches either the winning number for the first game or the winning number for the second game; and
awarding additional winnings to the player if the number wagered on by the player matches both the winning number for the first game and the winning number for the second game.

54. A method of playing progressive roulette comprising:
providing a roulette game;
receiving a first wager from a player on a number in the roulette game;
receiving a second wager from the player on a progressive number;
randomly selecting a winning roulette number;
randomly selecting a winning progressive number;
comparing the winning roulette number to the number wagered by the player;
comparing the winning progressive number to the progressive number wagered by the player;
awarding winnings to the player if the winning roulette number matches the number wagered by the player or if the winning progressive number matches the progressive number wagered by the player; and
awarding additional winnings to the player if both the winning roulette number matches the number wagered by the player and the winning progressive number matches the progressive number wagered by the player.
